(19) United States
(12) Patent Application Publication
(10) Pub. No.: US 2018/0163911 A1
(43) Pub. Date: Jun. 14, 2018

(54) Radiographic Testing Strap

(71) Applicant: Bryan Lutman, OREGON, OH (US)

(72) Inventor: Bryan Lutman, OREGON, OH (US)

(21) Appl. No.: 15/823,790

(22) Filed: Nov. 28, 2017

Related U.S. Application Data
(60) Provisional application No. 62/432,818, filed on Dec. 12, 2016.

(51) Int. Cl. F16L 55/07; G01N 23/02

(52) U.S. Cl. CPC F16L 55/07; G01N 23/02; G01N 2223/309; G01N 2223/308; G01N 2223/628

(57) ABSTRACT

A radiographic testing strap. The radiographic testing strap includes a flexible base including a first end and a second end. An open loop is disposed on the first end, and a latch sized to fit through the open loop is disposed on the second end. A plurality of pegs are disposed on an upper surface of the flexible base. The latch includes an inner edge configured to receive and engage one of the pegs. The radiographic testing strap can be wrapped around a pipeline or other object and secured thereto via frictional engagement between the latch and one of the plurality of pegs. The radiographic testing strap allows users to easily secure radiographic testing equipment to an object.

### CROSS REFERENCE TO RELATED APPLICATIONS

This application claims the benefit of U.S. Provisional Application No. 62/432,818 filed on Dec. 12, 2016. The above identified patent application is herein incorporated by reference in its entirety to provide continuity of disclosure.

### BACKGROUND OF THE INVENTION

The present invention relates to radiographic testing. More specifically, the present invention provides a radiographic testing strap that is configured to removably secure radiographic testing equipment to a pipeline or other object in order to inspect for structural damage.

Industrial radiography is utilized to examine the structural integrity of an object. One common use of industrial radiographic testing is to test the structural integrity of pipes around welds. Radiographic inspection can also be used to detect corrosion, waste buildup, and other structural defects. In order to test a section of pipe, the area to be tested is positioned between a radiation source and a detecting device, which is typically an X-ray film. The film is placed into a holder or a cassette which then must be secured to the pipe. If an individual holds the film in place, they will be exposed to radiation unless they protect themselves with lead aprons or other shielding apparatus. Currently, there is not an effective means for securing the film to the pipe.

In light of the devices disclosed in the known art, it is submitted that the present invention substantially diverges in design elements from the known art and consequently it is clear that there is a need in the art for an improvement to existing radiographic testing equipment securement devices. In this regard the present invention substantially fulfills these needs.

### SUMMARY OF THE INVENTION

In view of the foregoing disadvantages inherent in the known types of radiographic testing securement devices now present in the prior art, the present invention provides a radiographic testing strap wherein the same can be utilized for providing convenience for the user when testing objects such as pipes and aircraft for structural damage via X-ray radiation. The radiographic testing strap includes a flexible base including a first end and a second end. An open loop is disposed on the first end, and a latch sized to fit through the open loop is disposed on the second end. A plurality of pegs are disposed on an upper surface of the flexible base. The latch includes an inner edge configured to receive and engage one of the pegs. The radiographic testing strap can be wrapped around a pipeline or other object and secured thereto via frictional engagement between the latch and one of the plurality of pegs.

One object of the present invention is to provide a radiographic testing strap that allows users to easily secure radiographic testing equipment to an object.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the radiographic testing strap.

FIG. 2 shows a top plan view the radiographic testing strap.

FIG. 3 shows a side view of the radiographic testing strap.

FIG. 4 shows a perspective view of the radiographic testing strap securing radiographic testing equipment to a pipe.

### DETAILED DESCRIPTION OF THE INVENTION

Reference is made herein to the attached drawings. Like reference numerals are used throughout the drawings to depict like or similar elements of the radiographic testing strap. For the purposes of presenting a brief and clear description of the present invention, the preferred embodiment will be discussed as used for removably securing radiographic testing materials to an object to be tested for structural damage. The figures are intended for representative purposes only and should not be considered to be limiting in any respect.

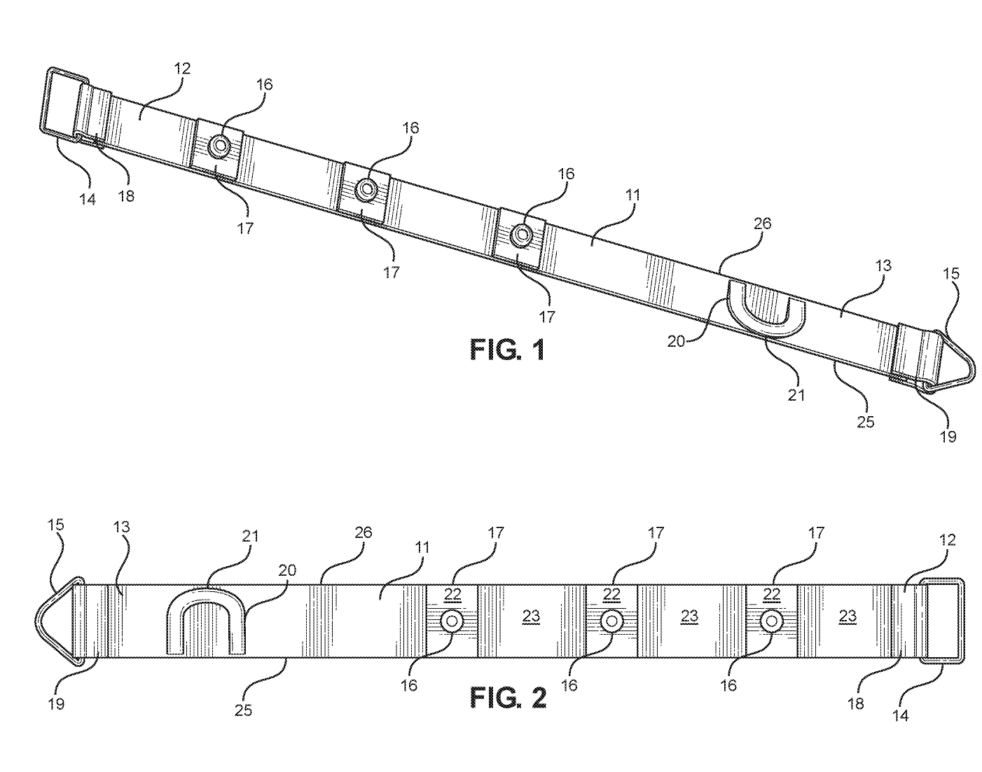

Referring now to FIGS. 1 and 2, there is shown a perspective view of the radiographic testing strap and a top plan view of the radiographic testing strap, respectively. The radiographic testing strap includes a flexible base 11 having a first end 12 and an opposing second end 13. An open loop 14 is disposed on the first end 12, and a latch 15 is disposed on the second end 13. In the shown embodiment, the open loop 14 includes a rectangular perimeter and the latch 15 includes a triangular perimeter. The latch 15 is sized such that it can be inserted through the open loop 14.

In the shown embodiment, the base 11 further includes a first fabric loop 18 disposed on the first end 12 and a second fabric loop disposed on the second end 13. The body of the open loop 14 is inserted through the first fabric loop 18, such that the open loop 14 is in sliding engagement with the first fabric loop 18. Similarly, the body of the latch 15 is inserted through the second fabric loop 19, such that the latch 15 is in sliding engagement with the second fabric loop 19. This allows the orientation of the open loop 14 and the latch 15 to be adjustable, adding versatility to the strap. In alternate embodiments, the open loop 14 can be fixedly attached to the first end 12 of the base 11, and the latch 15 can be fixedly attached to the second end 13 of the base 11.

A plurality of pegs 16 are disposed on the base 11. Each peg 16 is sized such that it can be received by an interior corner of the latch 15, effectively securing the base 11 in a loop configuration. The triangularity of the latch 15 provides an easily accessible interior angle to use as a latching point. In the shown embodiment, each peg 16 is disposed on a reinforcement patch 17. The reinforcement patch 17 extends across the base 11 from a first side edge 26 to a second side edge 25 thereof. The reinforcement patch 17 provides structural reinforcement to the pegs 16 and helps prevent the pegs 16 from detaching from the base 11 if a strong force is applied by the latch 15.

In the shown embodiment, a handle tab 20 is disposed on the base 11 for facilitating attachment and detachment of the radiographic testing strap from a structure to be tested. The handle tab extends outwardly and perpendicularly from the second side edge 25 of the base 11. In the shown embodiment, the handle tab 20 includes an arcuate terminal end 21 that facilitates grasping of the handle tab 20. The handle tab 20 is disposed between one of the pegs 16 and the latch 15 toward the latch end of the base 11. The handle tab 20 is positioned as such to allow for manipulation of the latch 15 when securing the strap to an object to be tested.

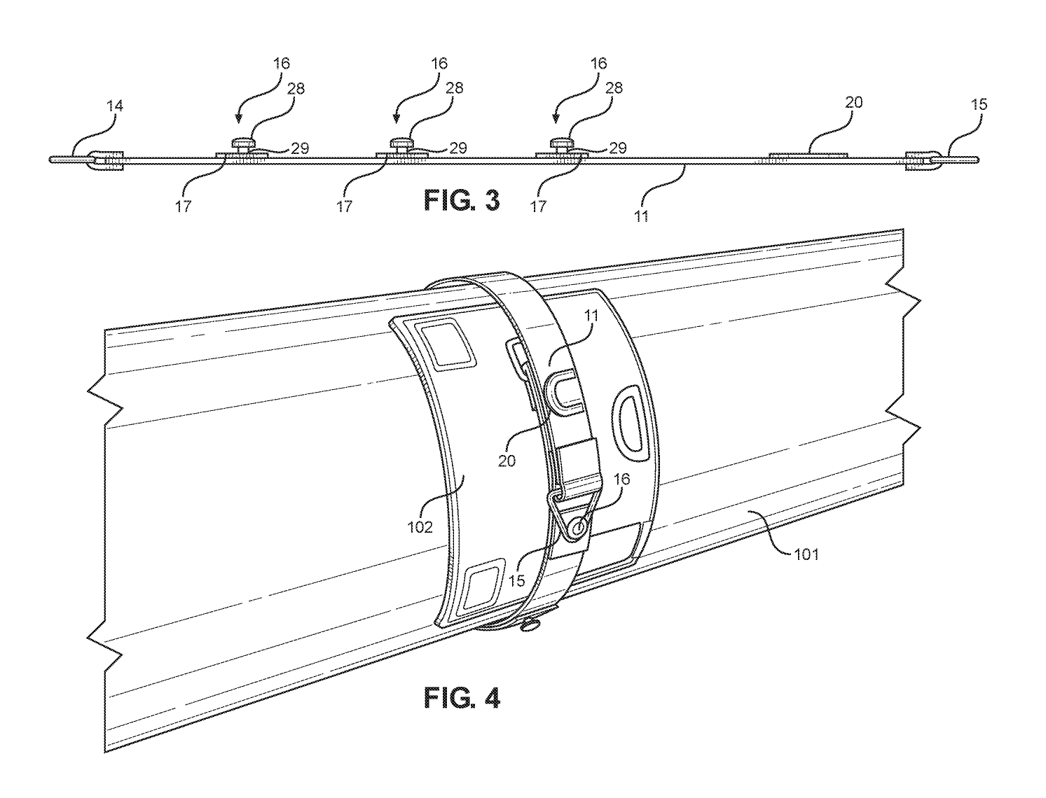

Referring now to FIG. 3, there is shown a side view of the radiographic testing strap. The reinforcement patch 17 extends upwardly from the base 11. Each of the reinforcement patch 17 and base 11 includes a planar surface. The reinforcement patch 17 is disposed in a first plane, and the base 11 is disposed in a second plane beneath the first plane. Each peg 16 includes a post 29 extending upwardly and perpendicularly from the reinforcement patch 17. A top portion 28 is disposed on an upper end of the post 29, and the top portion 29 includes a diameter greater than a diameter of the post 29. The inner edge of the latch 15 is configured to be removably securable to each peg 16 via frictional engagement between the top portion 28 and the reinforcement patch 17, such that the latch 15 applies a force to the post 29. The latch 15 can be inserted through the open loop 14 in order to adjust the length of the base 11 in its loop configuration.

Referring now to FIG. 4, there is shown a perspective view of the radiographic testing strap securing radiographic testing equipment to a pipe. The radiographic film holder 102 is positioned flush against the pipe 101. A user may then wrap the flexible base 11 of the strap around the film holder 102 and pipe 101, inserting the latch 15 through the open loop (not visible) in order to adjust the length of the strap. The user may then secure latch 15 to the peg 16 that ensures the film holder 102 is held in place against the pipe 101, using the handle tab 20 to pull the strap tight. After testing is completed, the user can easily unlatch the latch 15 from the peg 16 and remove the strap. Overall, the radiographic testing strap provides individuals with an effective means for removably securing a radiographic film holder to a section of pipe.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A radiographic testing strap, comprising:
a flexible base including a first end and a second end;
an open loop disposed on the first end;
a latch disposed on the second end sized to fit through the open loop;
a plurality of pegs disposed on an upper surface of the flexible base;
wherein the latch includes an inner edge configured to receive and engage one of the pegs.

2) The radiographic testing strap of claim 1, wherein the latch includes a triangular perimeter.

3) The radiographic testing strap of claim 1, wherein the open loop includes a square perimeter.

4) The radiographic testing strap of claim 1, wherein each peg of the plurality of pegs is disposed on a reinforcement patch, wherein each reinforcement patch extends from a first side of the base to a second side of the base.

5) The radiographic testing strap of claim 4, wherein each peg of the plurality of pegs includes a post and a top portion, wherein the inner edge of the latch is configured to be removably securable to each peg via frictional engagement between a lower side of the top portion and the reinforcement patch.

6) The radiographic testing strap of claim 4, wherein the reinforcement portion is disposed in a first plane, and wherein the flexible base is disposed in a second plane beneath the first plane.

7) The radiographic testing strap of claim 1, further comprising a first fabric loop disposed on the first end of the base and a second fabric loop disposed on the second end of the base, wherein a body of the open loop is inserted through the first fabric loop, and wherein a body of the latch is inserted through the second fabric loop.

8) The radiographic testing strap of claim 1, further comprising a handle tab disposed on the flexible base.

9) The radiographic testing strap of claim 8, wherein the handle tab is oriented perpendicular to the base and extends outwardly from a first side of the base, the handle tab including an arcuate terminal end.

10) The radiographic testing strap of claim 8, wherein the handle tab is disposed on the flexible base between one of the plurality of pegs and the latch.
